(19) United States
(12) Patent Application Publication
(10) Pub. No.: US 2021/0318151 A1
(43) Pub. Date: Oct. 14, 2021

(54) FLOW RATE MEASUREMENT DEVICE

(71) Applicant: Enplas Corporation, Saitama (JP)

(72) Inventors: Shimpei MORIOKA, Saitama (JP); Tsuyoshi WATANABE, Saitama (JP); Hayate KAWANO, Saitama (JP)

(73) Assignee: Enplas Corporation, Saitama (JP)

(21) Appl. No.: 17/226,187

(22) Filed: Apr. 9, 2021

(30) Foreign Application Priority Data
Apr. 10, 2020 (JP) 2020-070851

(51) Int. Cl. G01F 1/10

(52) U.S. Cl. CPC G01F 1/103

(57) ABSTRACT

A flow rate measurement device includes a channel; a flow detection part disposed at the channel, the flow detection part including an impeller configured to be rotated by a flow of the fluid and a reflection part disposed at the impeller and configured to reflect light; a light source configured to emit light toward the reflection part; and a detection part configured to receive light emitted from the light source and reflected by the reflection part. A width of a detection surface of the detection part intermittently or continuously changes in a movement direction of the reflection part along with rotation of the impeller as viewed in a direction orthogonal to a rotation axis of the impeller, or a width of a reflection surface of the reflection part intermittently or continuously changes in a rotational direction of the impeller.

### CROSS REFERENCE TO RELATED APPLICATIONS

This application is entitled to (or claims) the benefit of Japanese Patent Application No. 2020-070851, filed on Apr. 10, 2020, the disclosure of which including the specification, drawings and abstract is incorporated herein by reference in its entirety.

### TECHNICAL FIELD

The present invention relates to a flow rate measurement device.

### BACKGROUND ART

In the related art, the flow rate of fluid flowing through a channel pipe is measured by detecting the rotational speed of an impeller disposed in the channel pipe.

In addition, as a method for detecting the rotational speed of the impeller, a method using a magnetic sensor is known (see, for example, PTL 1). PTL 1 discloses a flow rate sensor including a channel pipe, an impeller disposed inside the channel pipe and configured to emit magnetism, and a magnetic sensor configured to detect the magnetism. In the flow rate sensor disclosed in PTL 1, the magnetism emitted from the impeller is detected using the magnetic sensor, and thus the flow velocity of the fluid is specified based on the rotational speed of the impeller.

In addition, a measurement device that calculates the distance to an object by using reflection light of emitted light is known (see, for example, PTL 2). In the measurement device disclosed in PTL 2, the time period from emission of light from an LD (laser diode) to detection of reflection light reflected by an object at a PD (photodetector) is measured to calculate the distance from the LD to the object.

### CITATION LIST

### Patent Literature

PTL 1

WO01/063221

PTL 2

Japanese Patent Application Laid-Open No. 2019-060670

### SUMMARY OF INVENTION

### Technical Problem

With the method for detecting the rotational speed of the impeller disclosed in PTL 1, however, the device size the cost may be increased due to the magnetic sensor used. Whether the impeller is rotating may be detected by using the optical system disclosed in

PTL 2 in the flow rate sensor disclosed in PTL 1. However, with the flow rate sensor disclosed in PTL 1 in which the optical system disclosed in PTL 2 is mounted, it is difficult to detect the rotational direction of the impeller.

An object of the present invention is to provide a flow rate measurement device that can detect the flow rate of the fluid flowing through the channel and the movement direction of the fluid with a simple structure.

### Solution to Problem

A flow rate measurement device of an embodiment of the present invention includes: a channel; a flow detection part disposed at the channel, the flow detection part including an impeller configured to be rotated by a flow of the fluid and a reflection part disposed at the impeller and configured to reflect light; a light source configured to emit light toward the reflection part; and a detection part configured to receive light emitted from the light source and reflected by the reflection part. A width of a detection surface of the detection part intermittently or continuously changes in a movement direction of the reflection part along with rotation of the impeller as viewed in a direction orthogonal to a rotation axis of the impeller, or a width of a reflection surface of the reflection part intermittently or continuously changes in a rotational direction of the impeller.

### Advantageous Effects of Invention

With the flow rate measurement device according to the present invention, it is possible to detect the flow rate of the fluid flowing through the channel and the movement direction of the fluid with a simple structure.

### BRIEF DESCRIPTION OF DRAWINGS

FIGS. 1A to 1E illustrate a configuration of a flow rate measurement device according to Embodiment 1 of the present invention;

FIGS. 2A and 2B are diagrams for describing a position of a reflection part;

FIGS. 3A to 3C are diagrams for describing a measurement principle of the flow rate of fluid flowing through a channel and a detection principle of the movement direction of the fluid;

FIGS. 4A to 4C are other drawings for describing a measurement principle of the flow rate of the fluid flowing through the channel and a detection principle of the movement direction of the fluid;

FIGS. 5A to 5C are other drawings for describing a measurement principle of the flow rate of the fluid flowing through the channel and a detection principle of the movement direction of the fluid; and

FIGS. 6A to 6C illustrate configurations of a detection part and a reflection part of Embodiment 2.

### DESCRIPTION OF EMBODIMENTS

A flow rate measurement device of an embodiment of the present invention is described below with reference to the accompanying drawings.

### Embodiment 1

### Configuration of Flow Rate Measurement Device

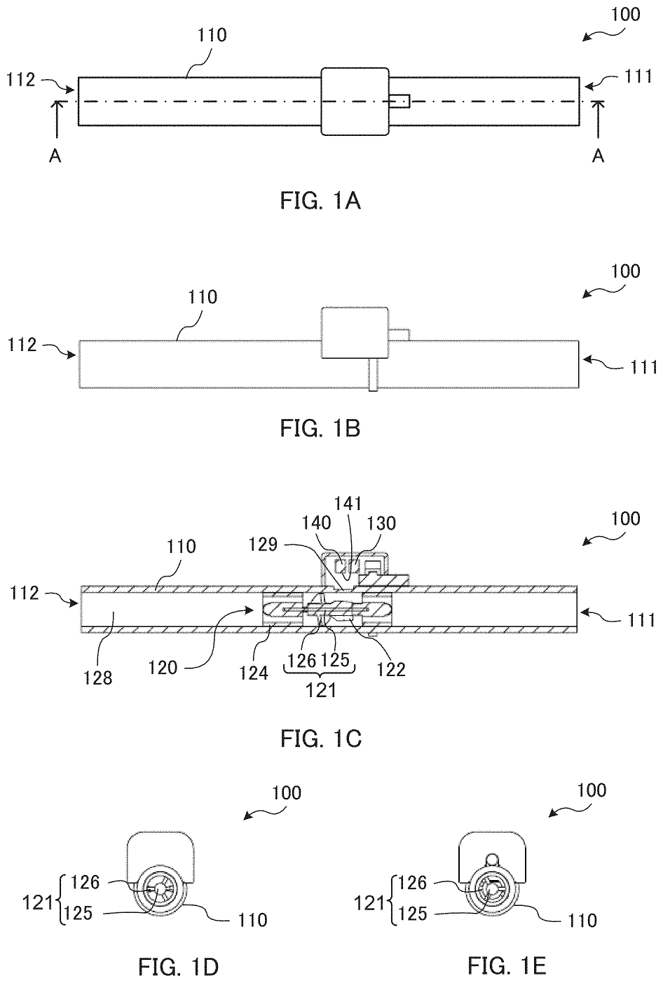

FIGS. 1A to 1E illustrate a configuration of a flow rate measurement device according to Embodiment 1 of the present invention. FIG. 1A is a plan view of flow rate measurement device 100, FIG. 1B is a front view, FIG. 1C is a sectional view taken along line A-A of FIG. 1A, FIG. 1D is a left side view, and FIG. 1E is a right side view.

As illustrated in FIGS. 1A to 1E, flow rate measurement device 100 includes channel pipe 110 through which fluid flows, flow detection part 120 including impeller 121 and reflection part 122, light source 130, and detection part 140. The term “fluid” means a material such as liquid and gas that can flow through channel 128. Examples of the fluid include water, or more specifically, clean water such as drinking water and agricultural water, and sewage such as factory wastewater.

Channel pipe 110 includes introduction part 111 for introducing the fluid into channel pipe 110, and ejection part 112 for ejecting the fluid to the outside of channel pipe 110. The interior of channel pipe 110 functions as channel 128.

It suffices that introduction part 111 has a structure capable of introducing the fluid into channel pipe 110. A given fluid supply device (not illustrated) may be connected to introduction part 111. Introduction part 111 may be disposed in the side wall of channel pipe 110, for example. Introduction part 111 may further include a channel for guiding the fluid in a given direction, and the like. Further, in introduction part 111, various structures for fitting and/or fixing a hose of a fluid supply device may be formed.

It suffices that ejection part 112 has a structure capable of ejecting, to the outside of flow rate measurement device 100, the fluid having flown through channel pipe 110. Ejection part 112 may not be disposed in the side wall of channel pipe 110, for example. Ejection part 112 may further include a channel for guiding the fluid in a given direction and the like. In addition, a given liquid storage device (not illustrated) may be connected to ejection part 112. Further, in ejection part 112, various structures for fitting and/or fixing a hose for ejecting the fluid from channel pipe 110 may be formed.

Channel 128 is a region for measuring the flow direction and the flow velocity of the flowing fluid. The shape of channel 128 is not limited as long as the above-mentioned functions can be ensured. Preferably, channel 128 has a substantially columnar shape from the viewpoint of appropriately ensuring the function of flow detection part 120 and carrying the fluid from introduction part 111 side toward ejection part 112 side without stagnation. The volume of channel 128 is not limited as long as the function of flow detection part 120 can be appropriately ensured.

In the present embodiment, in the upper part (a part between flow detection part 120 and detection part 140) of channel pipe 110, window part 129 for transmitting light from light source 130 toward channel 128 and transmitting light from channel 128 toward detection part 140 is provided. Window part 129 functions as a part of the exterior wall of channel pipe 110. Preferably, window part 129 is composed of a material with high transmittance to the light emitted from light source 130. Examples of the material of window part 129 include quartz (SiO₂), sapphire (Al₂O₃), and amorphous fluorine resin. In addition, in the case where light of a range of visible light to near-infrared light is emitted from light source 130, examples of the material of window part 129 include resins such as polymethyl methacrylate (PMMA), polycarbonate (PC), polyolefin, and polyetherimide (PEI). In addition, in the case where far-infrared light (of, e.g., a wavelength of 10 μm or greater) is emitted from light source 130, examples of the material of window part 129 include high density polyethylene (HDPE).

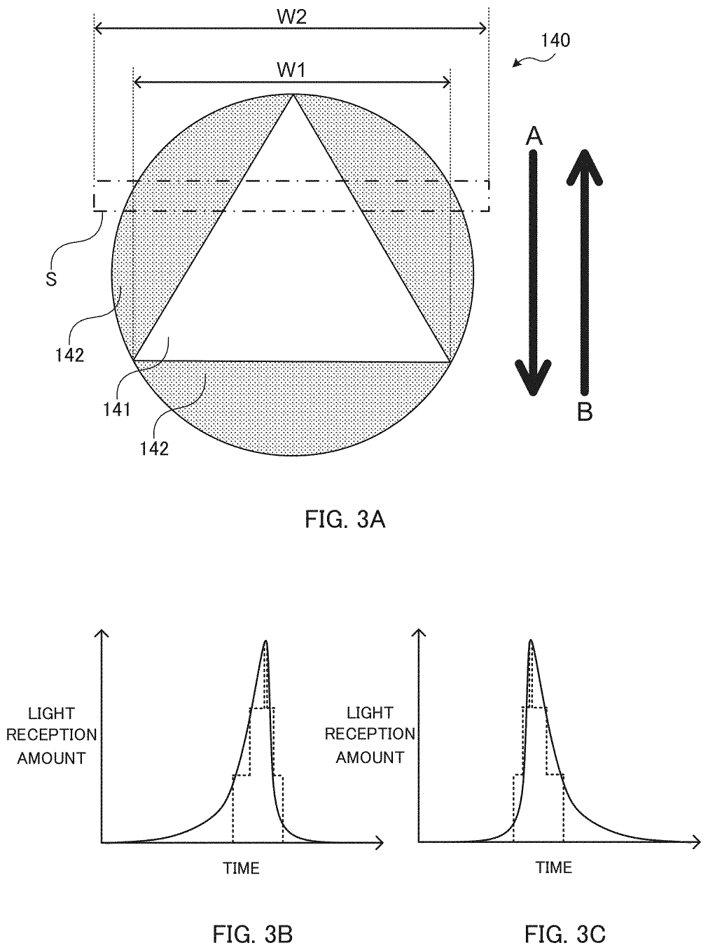

Light source 130 is a light source for emitting light disposed outside window part 129. The type and the like of light source 130 are not limited as long as light can be emitted toward reflection part 122 of flow detection part 120 disposed in channel 128. Examples of light source 130 include an LED, a mercury lamp, a metal halide lamp, a xenon lamp, and an LD. The central wavelength or the peak wavelength of the light emitted from light source 130 is not limited as long as the wavelength can be detected by detection part 140. In the present embodiment, preferably, width W2 of irradiation spot S, on detection part 140, of light emitted from light source 130 and reflected by reflection part 122 of flow detection part 120 is greater than width W1 of detection surface 141 (see FIG. 3A).

Flow detection part 120, which is disposed inside channel pipe 110, detects the flow of the fluid. Flow detection part 120 includes impeller 121 configured to be rotated by the flow of the fluid, and reflection part 122 for reflecting light disposed in impeller 121. The position of flow detection part 120 is not limited as long as it is disposed in channel 128 in such a manner that light from light source 130 can be applied thereto and that light reflected by reflection part 122 can be detected by detection part 140. Flow detection part 120 may be disposed on the introduction part 111 side, or on the ejection part 112 side, or, at the center in the flow direction of channel 128. In the present embodiment, flow detection part 120 is disposed at a center portion in the flow direction of channel 128 with supporting member 124 therebetween.

Impeller 121 includes shaft 125 and vane 126. In impeller 121, vane 126 is rotated about shaft 125 as the rotation axis by the flow of the fluid flowing through channel 128. Preferably, impeller 121 has a structure that does not significantly impair the flow of the fluid flowing through channel 128. In impeller 121, reflection part 122 for reflecting light is disposed at a position that rotates along with the rotation of impeller 121.

Reflection part 122 is a portion for reflecting, toward detection part 140, light emitted from light source 130. The position of reflection part 122 is not limited as long as it can rotate along with the rotation of impeller 121. Reflection part 122 may be disposed at shaft 125, at vane 126, or, at shaft 125 and vane 126. In the present embodiment, reflection part 122 is disposed at vane 126.

In the case where reflection part 122 is disposed at vane 126, reflection part 122 may be disposed at one vane 126, or at all vanes 126. In addition, reflection part 122 may be disposed only in a part of each vane 126, or in the entirety of each vane 126. Note that the width and the shape of reflection part 122 is not limited as long as a sufficient amount of light can be reflected toward detection part 140. The width and the shape of reflection part 122 may be adjusted in accordance with the sensitivity of detection part 140. Note that “the width of the reflection part” as used herein means the length of reflection part 122 in a direction orthogonal to the rotational direction of impeller 121.

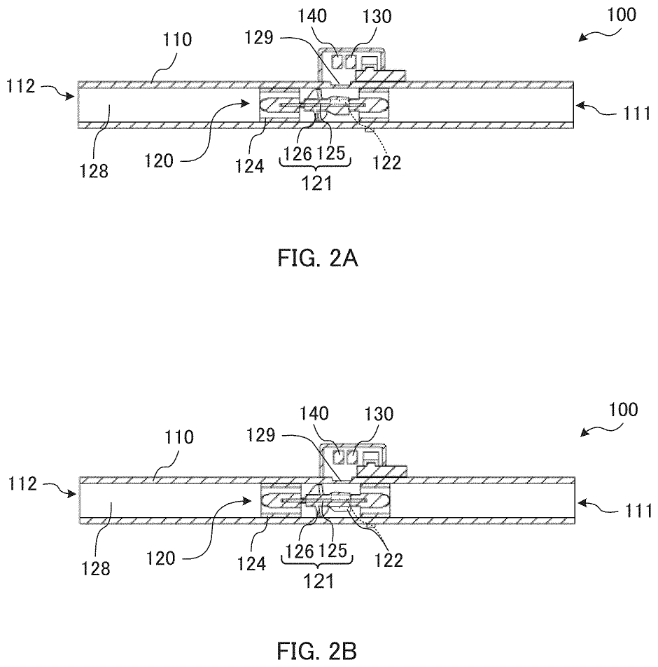

As illustrated in FIG. 2A, in the case where reflection part 122 is disposed at shaft 125, reflection part 122 may be disposed only in a part of the peripheral surface of shaft 125, or may be disposed over the whole circumference of shaft 125.

As illustrated in FIG. 2B, reflection part 122 may be disposed at both shaft 125 and vane 126 of impeller 121.

In the case where reflection part 122 is disposed in one vane 126 as in the present embodiment, a large amount of light is reflected to the detection part 140 side when detection part 140 and reflection part 122 face each other. On the other hand, when impeller 121 is rotated and detection part 140 and reflection part 122 face away from each other, the light does not reflected to the detection part 140 side. That is, the flow state of the fluid can be confirmed based on the variation of the amount of the light reflected toward detection part 140 with the rotation of impeller 121.

Impeller 121 is fabricated with a material such as resin and metal. For impeller 121, shaft 125 and vane 126 may be separately formed and combined together, or shaft 125 and vane 126 may be formed integrally with each other. In addition, the formation method of reflection part 122 is not limited, and for example, shaft 125 and/or vane 126 may be formed using resin or metal with high light reflectance. Alternatively, in shaft 125 and/or vane 126 formed using resin and the like with low light reflectance, a region with high light reflectance may be formed by providing plating, coating and the like.

Detection part 140 is disposed in such a manner as to face impeller 121 of flow detection part 120 through window part 129 of channel pipe 110. Detection part 140 receives light emitted from light source 130 and reflected by reflection part 122. Then, detection part 140 detects a variation in intensity of the light generated along with rotation of reflection part 122.

The type of detection part 140 is not limited as long as a variation in intensity of the light reflected by impeller 121 of flow detection part 120 can be detected. For example, detection part 140 is a photodiode (PD) including detection surface 141. While only one detection part 140 is disposed above impeller 121 (channel 128) in the present embodiment, a plurality of detection parts 140 may be disposed, and they may be disposed at a plurality of positions.

In the present embodiment, detection surface 141 of detection part 140 is configured such that the flow velocity of the fluid and the movement direction of the fluid can be detected with a width that is intermittently or continuously changes in the movement direction of reflection part 122 along with the rotation of impeller 121 as viewed in a direction orthogonal to the rotational direction of impeller 121.

Detection surface 141 may be configured such that the width of detection surface 141 is intermittently or continuously change in the movement direction of reflection part 122 in an independent manner. In addition, it may be configured with light shield surface 142 disposed in a part of detection surface 141 such that the width of detection surface 141 (the region not covered with light shield surface 142) intermittently or continuously changes in the movement direction of reflection part 122. In the present embodiment, as illustrated in FIG. 3A, a part of detection surface 141 is covered with light shield surface 142 such that the exposed region of detection surface 141 has a triangular shape in plan view. Width W1 of detection surface 141 in detection part 140 is smaller than width W2 of irradiation spot S of the light emitted from light source 130 and reflected by reflection part 122 in detection part 140. In this manner, when reflection part 122 moves, the amount of light that is reflected by reflection part 122 and detected at detection surface 141 continuously or intermittently changes, and thus the movement direction of the fluid can be detected. Note that “the width of detection surface 141” as used herein means the length of detection surface 141 in a direction orthogonal to the movement direction of reflection part 122. In addition, “the width of the irradiation spot” means the length of irradiation spot S in a direction orthogonal to the movement direction of reflection part 122.

Now, a measurement principle of the flow rate of the fluid flowing through channel 128 and a detection principle of the movement direction of the fluid are described below. FIGS. 3A to 3C are diagrams for describing a measurement principle of the flow rate of the fluid flowing through channel 128 and a detection principle of the movement direction of the fluid. FIG. 3A is a plan view of detection surface 141, FIG. 3B is a graph showing a variation in amount of light detected at detection surface 141 when irradiation spot S of reflection light from reflection part 122 moves in arrow direction A illustrated in FIG. 3A with respect to detection surface 141, and FIG. 3C is a graph showing a variation in amount of light detected at detection surface 141 when irradiation spot S of reflection light from reflection part 122 moves in arrow direction B illustrated in FIG. 3A with respect to detection surface 141. In FIGS. 3B and 3C, the abscissa indicates the time and the ordinate indicates the quantity of light (light reception amount) received at detection surface 141. In addition, in FIGS. 3B and 3C, the solid line indicates the measured value and the dotted line indicates the value obtained by converting the measured value into multiple values.

As illustrated in FIGS. 3A and 3B, when irradiation spot S of the reflection light moves in arrow direction A illustrated in FIG. 3A with respect to detection surface 141, the amount of the light detected at detection surface 141 gradually increases until the front end of irradiation spot S reaches the end portion (the lower end portion of FIG. 3A) of detection surface 141. The reason for this is that the ratio of the area of detection surface 141 in irradiation spot S gradually increases. Then, when the front end of irradiation spot S passes through the end portion of detection surface 141, the amount of the light detected at detection surface 141 abruptly decreases. The reason for this is that the ratio of the area of detection surface 141 in irradiation spot S abruptly decreases.

On the other hand, as illustrated in FIGS. 3A and 3C, when irradiation spot S of the reflection light moves in arrow direction B illustrated in FIG. 3A with respect to detection surface 141, the amount of the light detected at detection surface 141 abruptly increases until the rear end of irradiation spot S reaches the end portion (the lower end portion of FIG. 3A) of detection surface 141. The reason for this is that the ratio of the area of the detection surface in irradiation spot S abruptly increases. Then, when the rear end of irradiation spot S detection surface 141 passes through the end portion (the lower end portion of FIG. 3A), the amount of the light detected at detection surface 141 gradually decreases. The reason for this is that the ratio of the area of detection surface 141 in irradiation spot S gradually decreases.

As described above, the rate of change of the light reception amount per unit time differs between the case where light irradiation spot S moves in arrow direction A illustrated in FIG. 3A with respect to detection surface 141 and the case where light irradiation spot S moves in arrow direction B. Thus, as illustrated in FIGS. 3B and 3C, when light irradiation spot S moves in arrow direction A illustrated in FIG. 3A with respect to detection surface 141, or when light irradiation spot S moves in arrow direction B illustrated in FIG. 3A with respect to detection surface 141, the value obtained by converting the quantity of the light detected at detection surface 141 into multiple values repeats 0, 1, 2, 3, 2, and 1. As described above, even with the same multiple values, the rate of change of the light reception amount per unit time differs depending on the rotation direction of impeller 121. In this manner, the rotational direction of impeller 121 can be specified by examining the rate of change of the light reception amount per unit time in detection surface 141, and thus the movement direction of the fluid can be detected.

In addition, the rotational speed of impeller 121 can be specified by measuring the interval at which the light reception amount at detection part 140 has a predetermined light reception amount, and thus the flow rate of the fluid flowing through channel pipe 110 can be measured.

### Modification 1

Next, a flow rate measurement device according to Modification 1 is described. The flow rate measurement device according to Modification 1 differs from flow rate measurement device 100 according to Embodiment 1 only in configuration of detection part 240. In view of this, only detection part 240 is described below.

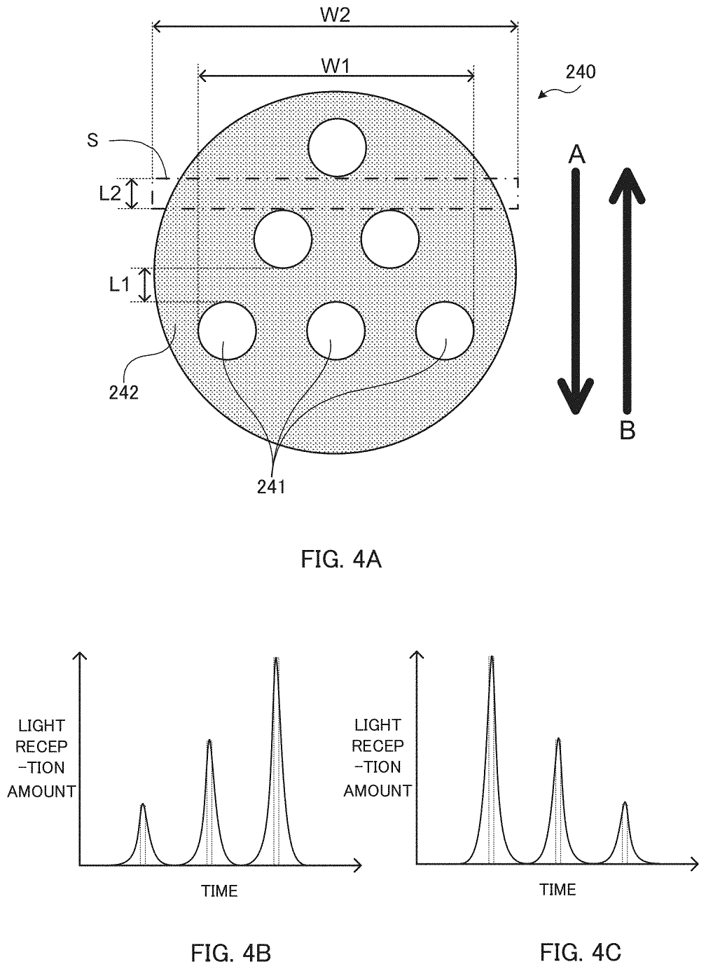

FIGS. 4A to 4C are diagrams for describing a measurement principle of the flow rate of the fluid flowing through channel 128 and a detection principle of the movement direction of the fluid. FIG. 4A is a plan view of detection surface 241, FIG. 4B is a graph showing a variation in amount of light detected at detection surface 241 when irradiation spot S of reflection light from reflection part 122 moves in arrow direction A illustrated in FIG. 4A with respect to detection surface 241, and FIG. 4C is a graph showing a variation in amount of light detected at detection surface 241 when irradiation spot S of reflection light from reflection part 122 moves in arrow direction B illustrated in FIG. 4A with respect to detection surface 241. In FIGS. 4B and 4C, the abscissa indicates the time and the ordinate indicates the quantity of light (light reception amount) received at detection surface 241. In addition, in FIGS. 4B and 4C, the solid line indicates the measured value and the dotted line indicates the value obtained by converting the measured value into multiple values.

As illustrated in FIGS. 4A to 4C, in detection part 240, detection surface 241 and light shield surface 242 that does not transmit the light may be alternately disposed in the movement direction of reflection part 122. More specifically, in the present embodiment, light shield surface 242 is disposed such that the number of divided detection surfaces 241 gradually increases as irradiation spot S moves in direction A illustrated in FIG. 4A. Preferably, in the movement direction of reflection part 122 along with the rotation of impeller 121 as viewed in a direction orthogonal to the rotation axis of impeller 121, distance L1 between adjacent two detection surfaces 241 is greater than length L2 of irradiation spot S of the light emitted from light source 130 at detection part 140. In addition, preferably, width W1 of detection surface 241 is smaller than width W2 of irradiation spot S of the light emitted from light source 130 at detection part 240. Here, the “width W1 of detection surface 241” means the length between the outer end portions of detection surfaces 241 at both ends in a direction orthogonal to the movement direction of reflection part 122 in a plane including the plurality of detection surfaces 241. In addition, the “width W2 of irradiation spot S” means the length of irradiation spot S in a direction orthogonal to the movement direction of reflection part 122 in a plane including detection surface 241.

As illustrated in FIGS. 4A and 4B, when light irradiation spot S moves in arrow direction A illustrated in FIG. 4A with respect to detection surface 241, the amount of the light detected at detection surface 241 repeatedly increases and decreases. The light is detected at detection surface 241 when irradiation spot S passes over detection surface 241, whereas no light is detected at detection surface 241 when irradiation spot S passes over only light shield surface 242. In addition, the quantity of the light detected at detection part 240 depends on the number of detection surfaces 241. Thus, as illustrated in FIG. 4B, when light irradiation spot S moves in arrow direction A illustrated in FIG. 4A with respect to detection surface 241, the value obtained by converting the quantity of the light detected at detection surface 241 into multiple values repeats 0, 1, 0, 2, 0, and 3.

On the other hand, as illustrated in FIGS. 4A and 4C, when light irradiation spot S moves in arrow direction B illustrated in FIG. 4A with respect to detection surface 241, the amount of the light detected at detection surface 241 repeatedly increases and decreases. The light is detected at detection surface 241 when irradiation spot S passes over detection surface 241, whereas no light is detected at detection surface 241 when irradiation spot S passes over only light shield surface 242. In addition, the quantity of the light detected at detection part 240 depends on the number of detection surfaces 241. Thus, when light irradiation spot S moves in arrow direction B illustrated in FIG. 4A with respect to detection surface 241, the value obtained by converting the quantity of the light detected at detection surface 241 into multiple values repeats 0, 3, 0, 2, 0, and 1 as illustrated in FIG. 4C.

As described above, the rate of change of the light reception amount per unit time differs between the case where light irradiation spot S moves in arrow direction A illustrated in FIG. 4A with respect to detection surface 241 and the case where light irradiation spot S moves in arrow direction B. That is, the rate of change of the light reception amount per unit time differs depending on the rotation direction of impeller 121. Thus, the movement direction of the fluid can be detected by examining the rate of change of the light reception amount per unit time at detection surface 241.

### Modification 2

Next, a flow rate measurement device according to Modification 2 is described. The flow rate measurement device according to Modification 2 differs from the flow rate measurement device according to Modification 1 only in detection part 340. Only detection part 340 is described below.

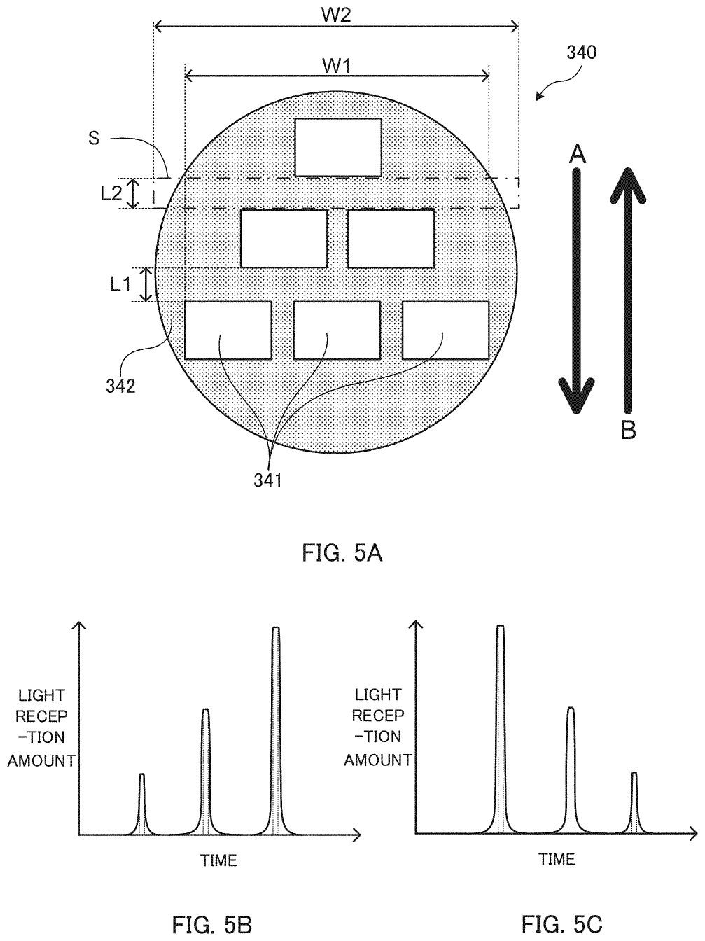

FIGS. 5A to 5C are other drawings for describing a measurement principle of the flow velocity of the fluid flowing through channel 128 and a detection principle of the movement direction of the fluid. FIG. 5A is a plan view of detection surface 341, FIG. 5B is a graph showing a variation in amount of light detected at detection surface 341 when irradiation spot S of reflection light from reflection part 122 moves in arrow direction A illustrated in FIG. 5A with respect to detection surface 341, and FIG. 5C is a graph showing a variation in amount of light detected at detection surface 341 when irradiation spot S of reflection light from reflection part 122 moves in arrow direction B illustrated in FIG. 5A with respect to detection surface 141. In FIGS. 5B and 5C, the solid line indicates the measured value and the dotted line indicates the value obtained by converting the measured value into multiple values.

As illustrated in FIG. 5A, in detection part 340, detection surfaces 341 and light shield surface 342 that does not transmit the light are alternately disposed in the movement direction of reflection part 122. In Modification 2, the shape of each of a plurality of divided detection surfaces 341 is a rectangular shape. In this case, as illustrated in FIGS. 5B and 5C, the light reception amount is easily detected, and the measurement accuracy of flow rate and the detection accuracy of the movement direction of the fluid can be increased.

### Effect

The flow rate measurement device of the present embodiment includes the detection surface that continuously or intermittently changes, and thus can measure the flow rate of the fluid flowing through the channel and can detect the movement direction of the fluid flowing through the channel.

### Embodiment 2

### Configuration of Flow Rate Measurement Device

The flow rate measurement device according to Embodiment 2 differs from flow rate measurement device 100 according to Embodiment 1 in configurations of detection part 440 and reflection part 422. In view of this, only configurations of detection part 440 and reflection part 422 are described below.

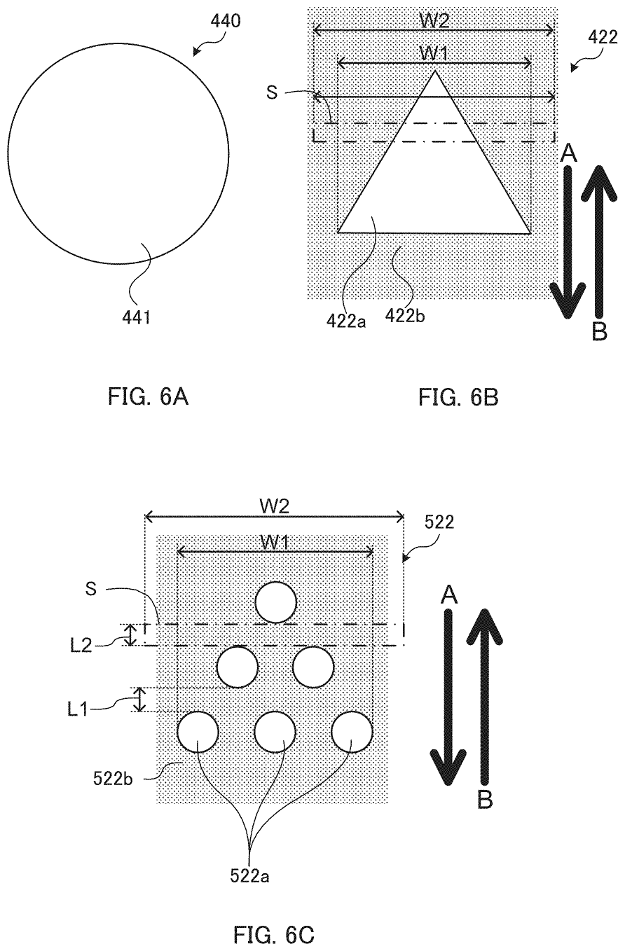

FIGS. 6A to 6C illustrate configurations of detection part 440 and reflection part 422 of Embodiment 2. FIG. 6A is a plan view of detection part 440 of Embodiment 2, FIG. 6B is a plan view of reflection part 422, and FIG. 6C is a plan view of another reflection part 522.

As illustrated in FIG. 6A, in the present embodiment, no light shield surface is disposed in detection surface 441 of detection part 440. The width of reflection surface 422a of reflection part 422 intermittently or continuously changes in the rotational direction of impeller 121. Reflection part 422 may have a configuration in which reflection surface 422a has the above-mentioned configuration, or may have a configuration in which reflection surface 422a has the above-mentioned configuration with non-reflection surface 422b disposed in a part of reflection surface 422a. In the present embodiment, as illustrated in FIG. 6B, a part of reflection surface 422a is covered with non-reflection surface 422b such that reflection surface 422a has a triangular shape in plan view. Width W1 of reflection surface 422a in reflection part 422 is smaller than width W2 of irradiation spot S of the light emitted from light source 130 at reflection surface 422a. In this manner, the amount of the light detected at detection surface 141 continuously or intermittently changes, and thus the detection accuracy for the movement direction of the fluid can be improved.

In addition, as illustrated in FIG. 6B, in reflection part 522, reflection surface 522a and non-reflection surface 522b that does not reflect the light may be alternately disposed in the rotational direction of impeller 121. More specifically, in the present embodiment, non-reflection surface 522b is disposed such that as irradiation spot S moves in direction A illustrated in FIG. 4A, the number of divided reflection surfaces 522a gradually increases. Preferably, in the rotational direction of impeller 121, length L1 between adjacent two reflection surfaces 522a is greater than length L2 of irradiation spot S of the light emitted from light source 130 at reflection part 122. In addition, preferably, width W1 of reflection surface 522a is smaller than width W2 of irradiation spot S of the light emitted from light source 130 at detection part 140.

### Effect

With the reflection surface that continuously or intermittently changes, the flow rate measurement device according to the present embodiment has an effect similar to that of Embodiment 1.

### INDUSTRIAL APPLICABILITY

The flow rate measurement device according to the embodiments of the present invention can readily determine the flow state of the fluid flowing through a channel with a simple structure. Therefore, it is very useful for various water processing facilities, water supply pipes, and the like.

### REFERENCE SIGNS LIST

100 Flow rate measurement device
110 Channel pipe
111 Introduction part
112 Ejection part
120 Flow detection part
121 Impeller
122, 422, 522 Reflection part
124 Supporting member
125 Shaft
126 Vane
128 Channel
129 Window part
130 Light source
140, 240, 340, 440 Detection part
141, 241, 341, 441 Detection surface
142, 242, 342 Light shield surface
422a, 522a Reflection surface
422b, 522b Non-reflection surface

1. A flow rate measurement device configured to measure a flow rate of fluid flowing through a channel by applying light to the fluid, the flow rate measurement device comprising:
the channel;
a flow detection part disposed at the channel, the flow detection part including an impeller configured to be rotated by a flow of the fluid and a reflection part disposed at the impeller and configured to reflect light;
a light source configured to emit light toward the reflection part; and
a detection part configured to receive light emitted from the light source and reflected by the reflection part,
wherein a width of a detection surface of the detection part intermittently or continuously changes in a movement direction of the reflection part along with rotation of the impeller as viewed in a direction orthogonal to a rotation axis of the impeller, or a width of a reflection surface of the reflection part intermittently or continuously changes in a rotational direction of the impeller.

2. The flow rate measurement device according to claim 1, wherein the width of the detection surface intermittently or continuously changes in the movement direction of the reflection part.

3. The flow rate measurement device according to claim 1, wherein the width of the reflection surface intermittently or continuously changes in the rotational direction of the impeller.

4. The flow rate measurement device according to claim 2,
wherein in the detection part, the detection surface and a light shield surface are alternately disposed in the movement direction of the reflection part, the light shield surface being a surface that does not transmit light; and
wherein a length between two of the detection surfaces adjacent to each other in the movement direction of the reflection part is greater than a length of an irradiation spot of the light emitted from the light source and reflected by the reflection part at the detection part.

5. The flow rate measurement device according to claim 3,
wherein in the reflection part, the reflection surface and a non-reflection surface are alternately disposed in the rotational direction of the impeller, the non-reflection surface being a surface that does not reflect light; and
wherein a length between two of the reflection surfaces adjacent to each other in the rotational direction of the impeller is greater than a length of an irradiation spot of light emitted from the light source at the reflection part.

6. The flow rate measurement device according to claim 4, wherein the width of the detection surface is smaller than a width of the irradiation spot of the light emitted from the light source and reflected by the reflection part at the detection part.

7. The flow rate measurement device according to claim 5, wherein the width of the reflection surface is smaller than a width of an irradiation spot of the light emitted from the light source at the reflection part.
